(19) United States
(12) Patent Application Publication
(10) Pub. No.: US 2026/0270297 A1
(43) Pub. Date: Sep. 10, 2026

(54) METHOD AND SYSTEM FOR DETECTING SOCIAL ENGINEERING ATTACKS

(71) Applicant: Protego LLC, SAN FRANCISCO, CA (US)

(72) Inventor: Arjun Singri, Newark, CA (US)

(21) Appl. No.: 19/073,787

(22) Filed: Mar. 7, 2025

(51) Int. Cl. H04L 9/40; H04L 41/16

(52) U.S. Cl. CPC H04L 63/1483; H04L 41/16

(57) ABSTRACT

Disclosed is a method and a system for detecting social engineering attacks by extracting content from applications running on an electronic device using system interaction interfaces. The extracted content is analysed to identify communication risk factors, such as linguistic patterns, contextual attributes, and behavioural anomalies, and a structured query is generated based on the analysis. The structured query is fed to an on-premise AI model, which assesses the likelihood of a potential social engineering attack and generates an output indicating the presence of such an attack. The output is received from the on-premise AI model, and an intervention prompt is generated based on the output. The intervention prompt facilitates verification of the sender’s authenticity within the application, enabling users to take proactive measures against potential threats. The method ensures real-time, privacy-preserving detection of social engineering attacks through local processing and context-aware interventions.

### DESCRIPTION

### Technical Field

The present invention relates to cybersecurity and, more specifically, to detection of social engineering attacks.

### Background

Social engineering attacks exploit human psychology to manipulate individuals into disclosing confidential information or performing actions that compromise security. Cyber criminals employ deceptive tactics such as impersonation, urgency-based requests, and financial fraud attempts to target users via emails, messaging platforms, and social media applications. Social engineering attacks, such as phishing, impersonation, and psychological manipulation, are increasingly prevalent and sophisticated. These attacks exploit human psychology rather than technical vulnerabilities, making them difficult to detect using traditional cybersecurity measures. Existing solutions cannot provide real-time, context-aware interventions to users.

Traditional security mechanisms, such as spam filters and authentication measures, fail to detect these threats effectively due to their reliance on static rules and signature-based detection.

### SUMMARY

To solve the above-mentioned problems, there is a need for a privacy-preserving, on-premise solution that can analyze communication content in real-time, identify social engineering tactics, and provide actionable interventions to users. The present disclosure addresses these challenges by leveraging on-premise Artificial Intelligence (AI) models for detecting social engineering attacks in real-time.

This disclosure addresses the critical challenge of detecting and mitigating social engineering attacks, which exploit human psychology rather than technical vulnerabilities, making them difficult to counter with traditional cybersecurity measures. By leveraging on-premise AI models, the invention provides a privacy-preserving, real-time solution that analyses communication content for risk factors such as linguistic patterns, behavioural anomalies, and contextual attributes. The disclosure provides for detecting social engineering attacks by generating context-aware intervention prompts, enabling users to verify the authenticity of suspicious messages and take proactive measures to mitigate risks. This approach not only enhances detection accuracy but also ensures data privacy by processing sensitive information locally, without transmitting it to external servers. The ability of this disclosure to integrate seamlessly with electronic devices and provide actionable, real-time interventions offers a significant advantage over existing solutions, making it a critical tool in combating the growing threat of social engineering attacks.

The social engineering detection system uses accessibility features on Android devices to extract conversations across various apps, including end-to-end encrypted platforms like WhatsApp. Users only need to grant permission for the system to use Accessibility features. The social engineering detection system employs an on-premise AI model to assess conversations for social engineering tactics, ensuring privacy as no data leaves the device. The on-premise AI model may support multiple languages, including, but not limited to, English, German, French, Italian, Portuguese, Hindi, Spanish, and Thai. The social engineering detection system is an optimum solution for public-safety solution to utilize on-premise AI. When the AI detects strong social engineering tactics, it provides interventions based on behaviour change theories in psychology, encouraging users to stop interacting with potential scammers. Additionally, the system uses cybersecurity technology to promote authentication between users, aiming to instil doubt in potential victims and prevent them from falling prey to scams.

In an embodiment, a method is disclosed for detecting social engineering attacks, the method includes extracting content from an application running on an electronic device using system interaction interfaces. The method further includes analysing the extracted content for identifying communication risk factors and generate a structured query based on the analysis. The method further includes feeding the structured query to an on-premise AI model that assesses a likelihood of a potential social engineering attack and generates an output indicating a presence of the potential social engineering attack on the application. The method further includes receiving the output from the on-premise AI model indicating the presence of the potential social engineering attack on the application. The method further includes generating an intervention prompt based on the output from the on-premise AI model, such that the intervention prompt is configured to facilitate verification of the sender’s authenticity within the application.

In an embodiment, the communication risk factors comprise linguistic patterns, contextual attributes, sender-related information, behavioural anomalies, psychological manipulation indicators, and message structure characteristics.

In an embodiment, the sender-related information comprises determining whether a sender of the extracted content is in a predefined contact list associated with the application and the behavioural anomalies comprises detecting unusual message patterns indicative of social engineering, including urgency, financial requests, or impersonation attempts. The linguistic patterns comprise classifying entities within the extracted content to identify persons, organizations, or government agencies, and the contextual attributes comprises assessing prior interactions with the sender to detect anomalies in conversation patterns.

In an embodiment, extracting the content comprises capturing text data or image-based text from the application.

In an embodiment, capturing image-based text includes using Optical Character Recognition (OCR) to extract textual information from screenshots or chat interfaces.

In an embodiment, the on-premise AI model assigns a confidence score to the likelihood of the social engineering attack.

In an embodiment, generation of the intervention prompt includes suggesting one or more verification questions based on the confidence score from the on-premise AI model.

In an embodiment, generation of the intervention prompt includes presenting a message that encourages scepticism towards a sender of the extracted content.

In an embodiment, generation of the intervention prompt includes displaying an authentication challenge to verify a sender of the extracted content.

In an embodiment, generation of the intervention prompt includes suggesting one or more verification questions based on prior interactions associated with a sender of the extracted content.

In an embodiment, generation of the intervention prompt includes displaying official cyber security advisories or government notices relevant to the potential social engineering attack.

In an embodiment, generation of the intervention prompt includes displaying a risk score indicating the likelihood of the extracted content being associated with the potential social engineering attack.

In an embodiment, generation of the intervention prompt includes highlighting suspicious linguistic patterns, such as urgency-based language or financial requests, within the extracted content.

In an embodiment, the verification questions are selected based on context of a message in the extracted content, including whether the sender is impersonating a known contact or a financial institution.

In an embodiment, filtering the extracted content upon determining, based on the output from the on-premise AI model, that the extracted content is associated with the potential social engineering attack.

In an embodiment, filtering comprises blocking, delaying, or restricting interactions based on the likelihood of the potential social engineering attack.

In an embodiment, feeding the structured query to the on-premise AI model includes utilizing Retrieval-Augmented Generation (RAG) to enhance detection accuracy by retrieving relevant threat intelligence data and incorporating it into the on-premise AI model’s response.

In an embodiment, integration of the application with the on-premise AI model using APIs supplied by the on-premise AI model for communication and processing such that the integration is performed using an AI model library.

In another embodiment, a system is disclosed that includes a processor and a memory that stores computer-executable instructions, which when executed by one or more processors, cause the one or more processors to execute operations. The operations comprise extracting content from an application running on an electronic device using system interaction interfaces. The operations further include analysing the extracted content to identify communication risk factors and generate a structured query based on the analysis. The operations further include feeding the structured query to an on-premise AI model that assesses a likelihood of a potential social engineering attack and generates an output indicating a presence of the potential social engineering attack on the application. The operations further include receiving the output indicating the presence of the potential social engineering attack on the application from the from the on-premise AI model. The operations further include generating an intervention prompt based on the output from the on-premise AI model such that the intervention prompt is configured to facilitate verification of the sender’s authenticity within the application.

In yet another embodiment, a non-transitory computer readable medium is disclosed that stores computer executable instructions, which when executed by one or more processors, cause the one or more processors to execute operations. The operations comprise extracting content from an application running on an electronic device using system interaction interfaces. The operations further include analysing the extracted content to identify communication risk factors and generate a structured query based on the analysis. The operations further include feeding the structured query to an on-premise AI model that assesses a likelihood of a potential social engineering attack and generates an output indicating a presence of the potential social engineering attack on the application. The operations further include receiving the output indicating the presence of the potential social engineering attack on the application from the from the on-premise AI model. The operations further include generating an intervention prompt based on the output from the on-premise AI model, wherein the intervention prompt is configured to facilitate verification of the sender’s authenticity within the application.

### BRIEF DESCRIPTION OF THE DRAWINGS

The present application can be best understood by reference to the following description taken in conjunction with the accompanying drawing figures, in which like parts may be referred to by like numerals.

FIG. 1 is a block diagram that illustrates an exemplary network environment for detection of social engineering attacks, in accordance with an embodiment of the present disclosure.

FIG. 2 is a block diagram of an exemplary electronic device of FIG. 1, in accordance with an embodiment of the present disclosure.

FIG. 3 is a block diagram that illustrates a social engineering detection system of FIG. 1 and FIG. 2, in accordance with an embodiment of the present disclosure.

FIG. 4 is a flow chart that illustrates operations of an exemplary method for detection of social engineering attacks, in accordance with an embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

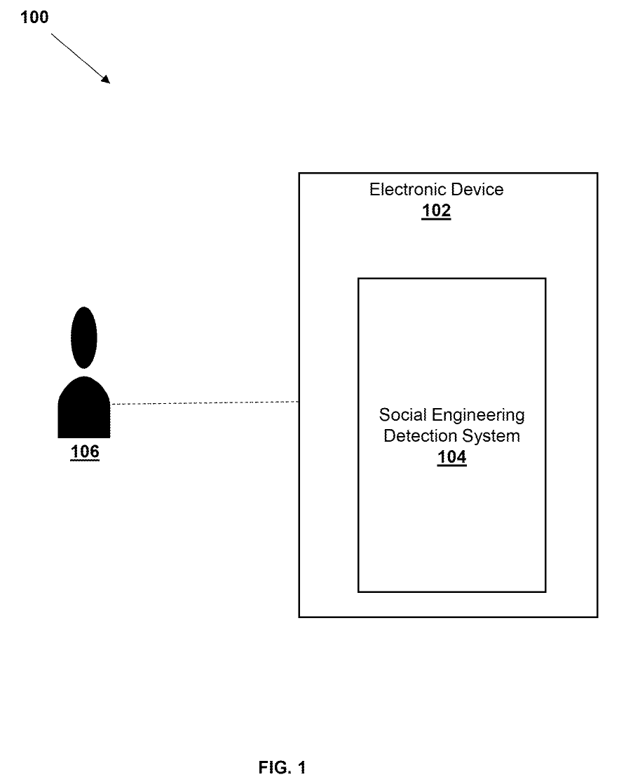

FIG. 1 is a block diagram that illustrates an exemplary network environment for detection of social engineering attacks, in accordance with an embodiment of the present disclosure. With reference to FIG. 1, there is shown a network environment 100. The network environment 100 may include an electronic device 102 and a social engineering detection system 104. The network environment 100 illustrates the interaction between three primary components, the electronic device 102, the social engineering detection system 104, and user 106 using applications in the electronic device 102.

The electronic device 102 may include, but is not limited to, a mobile phone, tablet, laptop, or any other portable or stationary computing device capable of running applications and supporting system interaction interfaces. The electronic device 102 is equipped with hardware components such as a processor, memory, network interface, and input/output (I/O) devices, enabling it to execute the functionalities of the social engineering detection system 104. The electronic device 102 serves as the primary platform for extracting content from applications, analysing communication data, and displaying intervention prompts to the user by supporting operating systems like Android, iOS, or other platforms.

The process begins with the electronic device 102, which may run various applications such as messaging platforms, email clients, or social media apps. These applications generate communication content, including text-based messages, emails, or chat conversations, which may potentially contain social engineering tactics. The social engineering detection system 104 interacts with the electronic device 102 to extract this communication content in real-time. Using the social engineering detection system 104, interaction interfaces such as the android accessibility service or optical character recognition (OCR) for iOS/Mac are employed to extract text data from applications running on the electronic device 102. These interfaces enable the social engineering detection system 104 to capture and reconstruct conversations, ensuring that all relevant content is available for analysis while maintaining user privacy and real-time processing capabilities. The social engineering detection system 104 captures and reconstructs the conversation format from the applications. Once the content is extracted, it is analysed by the social engineering detection system 104 to identify communication risk factors, such as suspicious linguistic patterns, behavioural anomalies, or contextual inconsistencies.

After analysing the content, the social engineering detection system 104 generates a structured query based on the identified risk factors. This query is then fed into an on-premise AI model hosted by the electronic device 102 itself. The on-premise AI model assesses the likelihood of a social engineering attack. The AI model evaluates the query, assigns a confidence score to indicate the probability of an attack, and generates an output that flags potential threats. The output is sent back to the social engineering detection system 104, which processes it and determines the appropriate response. Based on the AI model’s output, the social engineering detection system 104 generates an intervention prompt tailored to the specific threat detected. This prompt is displayed to the user 106 on their electronic device 102, providing actionable guidance to verify the authenticity of the communication. For example, the prompt may include verification questions, an authentication challenge, or a warning message highlighting suspicious elements in the content. The user 106 can then take proactive steps to mitigate the risk, such as confirming the identity of the sender or avoiding further interaction with the suspicious message. Throughout this process, the social engineering detection system 104 operates seamlessly in the background, ensuring minimal disruption to the user’s experience while providing robust protection against social engineering attacks.

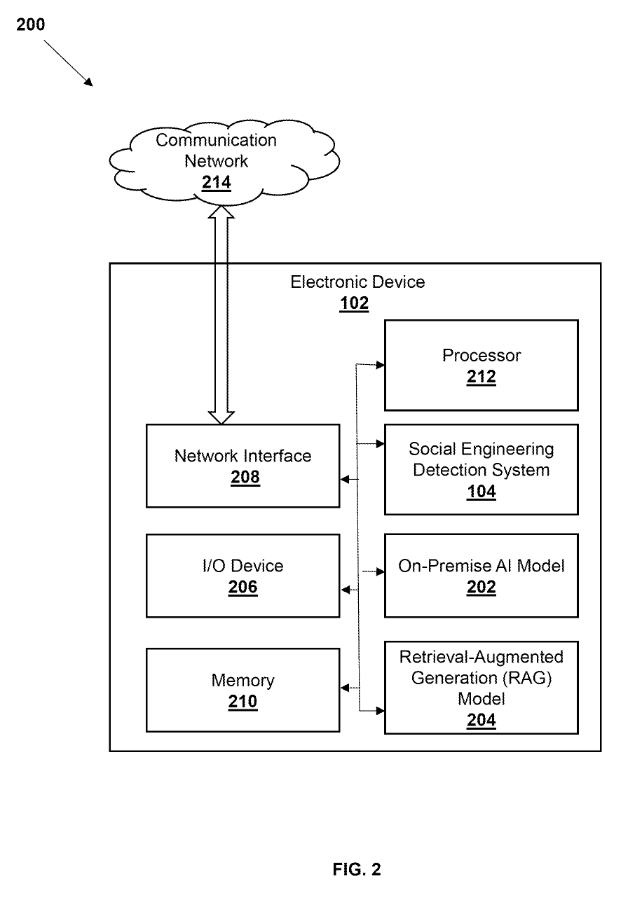

FIG. 2 illustrates a block diagram of an electronic device, in accordance with an embodiment of the present disclosure. With reference to FIG. 2, there is shown a block diagram 200 of the electronic device 102 within the network environment 100. The electronic device 102 may comprise an on-premises AI model 202, a retrieval augmented generation model (RAG) 204, an Input/Output (I/O) device 206, a network interface 208, a memory 210, a processor 212, and a communication network 214.

In an embodiment, the on-premise AI model 202 is responsible for assessing the likelihood of social engineering attacks based on structured queries generated by the social engineering detection system 104. This on-premise AI model 202 operates locally on the electronic device 102, ensuring data privacy and real-time processing without the need to transmit sensitive information to external servers. The on-premise AI model 202 may be built using advanced deep learning architectures and techniques, such as transformer-based models like BERT and GPT, which are fine-tuned to detect social engineering tactics. Additionally, LaMDA (Language Model for Dialogue Applications), developed by Google, may be suited for handling nuanced conversations and identifying psychological manipulation or impersonation attempts. Other models may include RoBERTa (Robustly Optimized BERT Pretraining Approach), which enhances BERT by training on larger datasets, and T5 (Text-To-Text Transfer Transformer), which frames tasks as text-to-text problems for versatile applications like text classification and anomaly detection. XLNet, combining autoregressive and autoencoding strengths, offers superior context understanding. Furthermore, models like ChatGPT^{©}, BlenderBot^{©} and LLaMA^{©} (Large Language Model Meta AI), developed by Meta, may provide robust capabilities for open-domain dialogue and foundational NLP research, respectively. When fine-tuned on datasets containing social engineering examples, these models can effectively identify suspicious patterns, linguistic cues, and behavioural anomalies in communication content, making them ideal for the on-premise AI model 202.

The Large Language Model (LLM) may be integrated with the on-premise AI model 202 to enhance its functionality and accuracy in detecting social engineering attacks. The on-premise AI model 202, built using transformer-based architectures like BERT, GPT, RoBERTa, or T5, serves as the primary engine for evaluating structured queries generated from extracted content. The LLM may act as a sub-component, leveraging its advanced natural language understanding capabilities to analyse text data, identify subtle social engineering patterns (e.g., phishing, impersonation, urgency-based language), and assess linguistic patterns, contextual attributes, and behavioural anomalies. By combining the LLM with Retrieval-Augmented Generation (RAG), the system retrieves relevant threat intelligence data (e.g., phishing logs, cybersecurity reports) from external databases, refining the LLM’s assessment with additional context. The LLM may assign a confidence score to the queries, indicating the likelihood of an attack, which is used by the intervention module 310 to generate context-aware prompts for the user.

The on-premise AI model 202 evaluates structured queries, which include extracted text data and metadata (e.g., sender information, timestamps, and contextual attributes). The on-premise AI model 202 may employ contextual risk analysis algorithms to identify patterns indicative of social engineering, such as suspicious linguistic cues, behavioural anomalies, or inconsistencies in the communication context. The on-premise AI model 202 outputs a confidence score that quantifies the likelihood of a social engineering attack, enabling the social engineering detection system 104 to prioritize and respond to high-risk threats effectively. The on-premise nature of the AI model 202 may ensure that all processing occurs locally, minimizing latency and enhancing user privacy.

In an embodiment, the RAG model 204 works in conjunction with the on-premise AI model 202 to enhance the accuracy and contextual understanding. The RAG model 204 may retrieve relevant threat intelligence data from external sources, such as cybersecurity reports, phishing attempt logs, and contextual databases, and incorporates this information into the assessment process of on-premise AI model 202. This retrieval of relevant threat intelligence data allows the social engineering detection system 104 to adapt to evolving social engineering tactics and incorporate real-time threat data into its analysis.

The RAG model 204 operates by first querying external databases through the network interface 208 to fetch relevant information. For example, if the extracted content contains a suspicious link or sender details, the RAG model 204 retrieves historical data about similar links or sender profiles from threat intelligence repositories. This retrieved data is then fed into the on-premise AI model 202, enabling it to make more informed and accurate assessments. By combining local AI processing with external threat intelligence, the RAG model 204 significantly enhances the ability of the social engineering detection system 104 to detect sophisticated social engineering attacks.

In an embodiment, the I/O device 206 serves as the interface between the user 106 and the social engineering detection system 104, facilitating seamless interaction and communication. The I/O device 206 is responsible for displaying intervention prompts, warnings, and other notifications generated by the social engineering detection system 104 to the user 106. For example, if the on-premise AI model 202 detects a high-risk social engineering attempt, the I/O device 206 displays a prompt asking the user 106 to verify the authenticity of the sender or avoid interacting with the suspicious content. The I/O device 206, may also capture user inputs, such as responses to verification questions or authentication challenges, and relays them back to the social engineering detection system 104 for further processing. This bidirectional communication ensures that the user 106 remains informed and empowered to take proactive measures against potential threats. The I/O device 206 is designed to provide a user-friendly experience, with clear and concise prompts that minimize confusion and encourage safe online behaviour.

The I/O device 206 may include suitable logic, circuitry, interfaces, and/or code that may be configured to receive an input and provide an output based on the received input. The I/O device 206 may also include the display device. Examples of the I/O device 206 may include, but are not limited to, a display (e.g., a touch screen), a keyboard, a mouse, a joystick, a microphone, or a speaker. Examples of the I/O device 206 may further include braille I/O devices, such as braille keyboards and braille readers.

In an embodiment, the network interface 208 enables communication between the electronic device 102 and external components such as threat intelligence databases, cybersecurity repositories, and the social engineering detection system 104. The network interface 208 facilitates the retrieval of external threat intelligence data for the operation of the RAG Model 204. The network interface 208 uses secure communication protocols (e.g., HTTPS, TLS) to ensure that data transmission is encrypted and protected from interception or tampering.

In addition to supporting the RAG Model 204, the network interface 208 also allows the social engineering detection system 104 to receive updates to the on-premise AI model 202, such as new training data or model weights, ensuring that the social engineering detection system 104 remains up-to-date with the latest threat detection capabilities. By enabling seamless connectivity with external resources, the network interface 208 enhances the ability of the social engineering detection system 104 to detect and respond to emerging social engineering threats.

The network interface 208 may include suitable logic, circuitry, interfaces, and/or code that may be configured to facilitate communication between the electronic device 102 and the communication network 214. The network interface 208 may be implemented by use of various known technologies to support wired or wireless communication of the electronic device 102 with the communication network 214. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

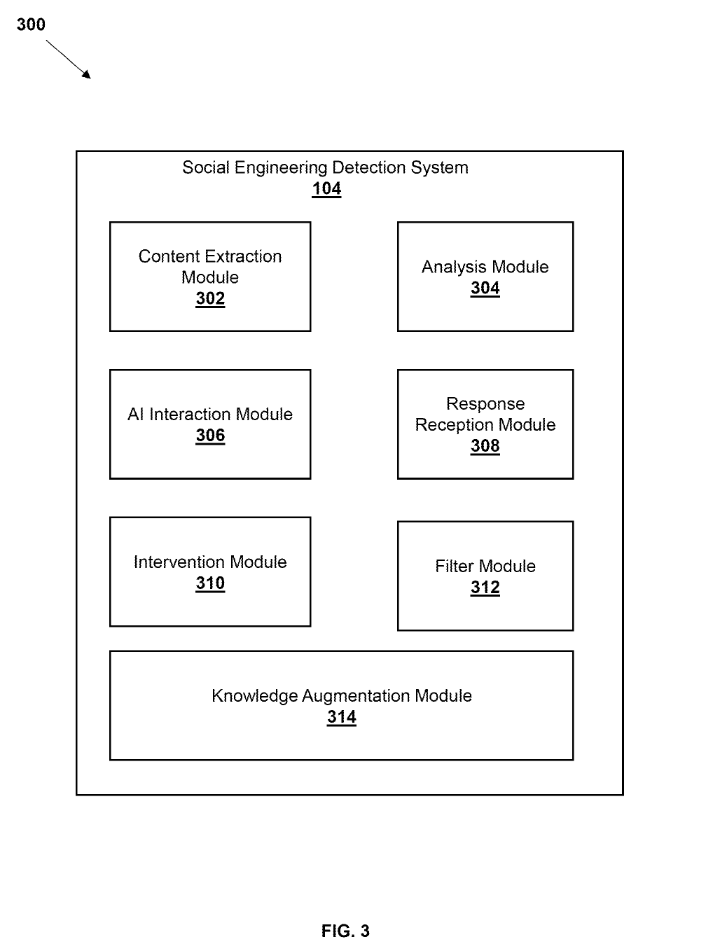

In an embodiment, the memory 210 serves as the storage hub for all critical data and components required for the system’s operation. The memory 210 stores extracted content from applications, structured queries generated by the analysis module 304(shown in FIG. 3), and outputs from the on-premise AI model 202. Additionally, the memory 210 retains AI model weights, user interaction logs, and past analysis results, enabling the social engineering detection system 104 to learn from historical data and improve its detection accuracy over time.

The memory 210 also supports the RAG Model 204 by caching frequently accessed threat intelligence data, reducing the need for repeated external queries and improving the efficiency. By providing fast and reliable access to stored data, the memory 210 ensures that the social engineering detection system 104 can perform real-time analysis and generate timely intervention prompts.

The memory 210 may include suitable logic, circuitry, interfaces, and/or code that may be configured to store one or more instructions to be executed by the processor 212. The one or more instructions stored in the memory 210 may be configured to execute the different operations of the processor 210 (and/or the electronic device 102). Examples of implementation of the memory 210 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

In an embodiment, the processor 212 is the computational engine that executes all real-time tasks required for the operation of social engineering detection system 104. The processor 212 handles content extraction, analysis, AI model inference, and intervention prompt generation. The processor 212 is optimized for high-performance computing, enabling it to process large volumes of data quickly and efficiently.

For example, when the content extraction module 302(shown in FIG. 3) captures text data from an application, the processor 212 reconstructs the conversation format and prepares it for analysis. The processor 212 then executes the algorithms used by the analysis module 304 to identify communication risk factors and generate structured queries. Finally, the processor 212 runs the on-premise AI model 202 and the RAG Model 204 to assess the likelihood of a social engineering attack and generate intervention prompts. By coordinating these tasks, the processor 212 ensures that the social engineering detection system 104 operates seamlessly and delivers real-time protection to the user 106.

The processor 212 may include suitable logic, circuitry, and/or interfaces that may be configured to execute program instructions associated with different operations to be executed by the electronic device 102. The operations may include source audio reception, reference-speaker audio reception, reference-emotion audio reception, set of ML models application, converted audio generation, classifier application, and adversarial model retraining. The processor 212 may include one or more processing units, which may be implemented as a separate processor. In an embodiment, the one or more processing units may be implemented as an integrated processor or a cluster of processors that perform the functions of the one or more specialized processing units, collectively. The processor 212 may be implemented based on a number of processor technologies known in the art. Examples of implementations of the processor 212 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

In an embodiment, the communication network 214 connects the electronic device 102 to external entities such as threat intelligence databases and cybersecurity repositories. The communication network 214 enables the RAG model 204 to retrieve relevant threat intelligence data and incorporate it into the assessment process of the on-premise AI model 202. The communication network 214 uses secure and reliable protocols to ensure that data transmission is protected from unauthorized access or tampering.

In addition to supporting the RAG Model 204, the communication network 214 also facilitates updates to the on-premise AI model 202 and other components. By maintaining a robust and secure connection to external resources, the communication network 214 enhances the ability of social engineering detection system 104 to detect and respond to evolving social engineering threats.

The communication network 214 may include a communication medium through which the electronic device 102 and the network interface 208 may communicate with each other. The communication network 214 may be one of a wired connection or a wireless connection. Examples of the communication network 214 may include, but are not limited to, the Internet, a cloud network, Cellular or Wireless Mobile Network (such as Long-Term Evolution and 5^{th} Generation (5G) New Radio (NR)), satellite communication system (using, for example, a network of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 214 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

FIG. 3 is a block diagram that illustrates a social engineering detection system of FIG. 1 and FIG. 2, in accordance with an embodiment of the present disclosure. With reference to the FIG. 3 there is shown a block diagram 300 of the social engineering detection system 104 of the network environment 100. The social engineering detection system 104 may include content extraction module 302, analysis module 304, AI interaction module 306, response reception module 308, intervention module 310, filter module 312, and a knowledge augmentation module 314.

In an embodiment, the content extraction module 302 is responsible for extracting textual data from applications running on an electronic device 102. The content extraction module 302 ensures seamless data retrieval from messaging applications while maintaining platform compatibility, security, and real-time processing efficiency. The extraction approach varies based on the operating system to ensure compliance with platform constraints and encryption mechanisms.

The content extraction module 302 may extract text data from applications running on user devices (such as the electronic device 102) using interaction interfaces. For Android devices, the content extraction module 302 leverages the accessibility service API, while for iOS/Mac devices, it may utilize iOS Accessibility APIs, such as VoiceOver or AssistiveTouch, to programmatically access and extract text data from UI elements. The social engineering detection system 104 may also be extended to support Windows mobile phones, where it may utilize windows accessibility APIs, such as UI Automation, to extract text data from applications running on the device.

For android devices, the content extraction module 302 may leverage the accessibility service Application Programming Interface (API) as a system interaction interface. The accessibility service API is a system-provided interface that enables applications to retrieve and interact with text displayed on the screen. By accessing UI elements directly, the module extracts structured text data from messaging applications such as SMS, WhatsApp©, and other communication platforms. This method ensures that all visible content in a conversation, including sender metadata, timestamps, and message structure, is captured and reconstructed in a coherent format. Since end-to-end encryption protects stored messages, the content extraction module 302 does not access raw message storage but instead captures only the text that is visible to the user. The extracted text is dynamically updated with each new message, ensuring that the content remains current for analysis.

For iOS and Mac devices, direct UI-based extraction may be restricted due to security policies, which prevent the use of Accessibility Services in third-party applications. To overcome this limitation, the content extraction module 302 may employ Optical Character Recognition (OCR) to extract textual information from screenshots or chat interfaces. OCR technology processes pixel-based images of messages, converting them into machine-readable text. The OCR technology functions by pre-processing images to enhance contrast and remove noise, segmenting characters and words, and applying pattern recognition models to distinguish text from UI elements such as buttons, emojis, and timestamps. Additionally, error correction techniques and linguistic modelling enhance accuracy, particularly for partially obscured or distorted text. This approach ensures compatibility with secure messaging applications while maintaining the integrity of encrypted communication.

Additionally, the content extraction module 302 may include accessibility features for iOS/Mac. This may involve leveraging iOS Accessibility APIs, such as VoiceOver or AssistiveTouch, to programmatically access and extract text data from UI elements within applications running on iOS/Mac devices. This addition may extend the functionality of the social engineering detection system 104 to iOS/Mac users, enabling cross-platform support for detecting social engineering attacks.

Furthermore, the content extraction module 302 may incorporate real-time OCR processing to convert image-based text into structured text suitable for analysis. The OCR technology supports multiple languages and font styles, enhancing its recognition accuracy across diverse messaging platforms. The extraction process may involve pre-processing images (grayscale conversion, binarization), segmenting characters, and applying AI-based pattern recognition to distinguish text from graphical artifacts. The OCR technology is particularly optimized for chat interfaces, detecting speech bubbles, timestamps, usernames, and contextual markers. By integrating real-time screenshot processing, the content extraction module 302 may ensures that OCR execution occurs instantly when new messages appear, maintaining an up-to-date and reliable extraction system.

Additionally, the content extraction module 302 may facilitate direct access to message data from the messaging application on the end-user client device, without utilizing accessibility services or OCR. This functionality is achieved by leveraging messaging application APIs or client-side data access mechanisms provided by the operating system or the messaging platform. For example, messaging applications like WhatsApp, Telegram, or SMS apps often provide APIs or local storage access that allows the social engineering detection system 104 to retrieve message content directly, including raw message data, metadata, sender details, timestamps, and attachments. The extracted content is then fed to the on-premise AI model 202 for evaluation, ensuring real-time analysis of communication risk factors. This approach eliminates the need for accessibility features or OCR, making the social engineering detection system 104 more efficient and broadly applicable across different platforms and applications.

The content extraction module 302 is further enhanced to support both UI-based extraction (using Accessibility Services or OCR) and direct client-side message access, ensuring maximum compatibility with different messaging platforms. When direct access is available, the module securely retrieves message data from the messaging app's local client-side storage, preserving text formatting, embedded hyperlinks, attachments, and other contextual information that might otherwise be lost during UI-based extraction. This direct retrieval method enhances social detection engineering system 104 performance by reducing processing overhead associated with screen parsing and image-to-text conversion, ensuring faster and more accurate content extraction.

In an embodiment, the analysis module 304 is responsible for processing extracted content to identify potential communication risk factors associated with social engineering attacks. The analysis module 304 processes the complete conversation visible on a display screen of the application running on the electronic device 102, analysing each message added by any party in real-time. The analysis module 304 identifies communication risk factors, such as linguistic patterns, contextual attributes, and behavioural anomalies, and generates structured queries for further evaluation by the on-premise AI model 202. Every message that gets added by any of the parties in the conversation results in a new analysis. This ensures continuous and dynamic analysis of the conversation for potential social engineering threats. The analysis module 304 performs a multi-layered analysis of textual data, considering various aspects such as linguistic patterns, contextual attributes, sender-related information, and behavioural anomalies to determine whether a conversation exhibits characteristics of fraudulent or deceptive intent. By evaluating communication trends and deviations from established conversational norms, the module ensures a highly accurate and context-aware assessment of risk.

The analysis module 304 may identify communication risk factors based on key indicators observed within extracted content. Linguistic patterns are analysed to detect suspicious phrasing, including urgency-based language that pressures the recipient into immediate action, emotionally manipulative statements, and persuasive language that is often used in phishing or fraud attempts. The analysis module 304 evaluates contextual attributes by examining the nature of the conversation, its subject matter, and prior interactions between the sender and recipient to determine whether an exchange deviates from normal expectations. Sender-related information is extracted to verify whether the sender is a known and trusted entity within the contact list of the user 102, and whether their communication style aligns with previous interactions. Additionally, the analysis module 304 examines behavioural anomalies, such as a sudden shift in tone, excessive use of financial terms, or an unusual frequency of messages that indicate an attempt to manipulate the recipient.

Additionally, the analysis module 304 performs an in-depth entity classification and behavioural analysis to detect impersonation attempts and inconsistencies in message patterns. Sender-related information is validated by cross-referencing the extracted data with a predefined contact list associated with the application. If a sender claims to represent an organization, government agency, or financial institution, the analysis module 304 verifies whether such claims match publicly known contact details and communication styles. Furthermore, behavioural anomalies are detected by identifying deviations from previously recorded interaction patterns. For example, if a contact who has never previously discussed financial matters suddenly requests sensitive banking details, this abrupt change in communication style is flagged as suspicious. Similarly, if a sender frequently uses capitalized words, excessive exclamation points, or employs high-pressure tactics, the module categorizes the message as containing potential psychological manipulation indicators.

The analysis module 304 may also include functionality for malicious link detection within the extracted content. Instead of relying on an LLM, this functionality utilizes an external service to analyze and categorize hyperlinks for malicious intent, such as phishing or malware distribution. The external service evaluates the links and provides a classification (e.g., safe, suspicious, or malicious), which is incorporated into the structured query generated by the Analysis Module 304. This enables the on-premise AI model 202 to assess the overall risk of the communication, including both textual content and hyperlinks, thereby enhancing the ability of social engineering detection system 104 to detect and mitigate social engineering attacks that rely on malicious links.

Additionally, the analysis module 304 may also include functionality for misinformation categorization within the extracted content. The LLM (Large Language Model) is utilized to summarize the message, capturing its key points and context. The summarized content is then fed into an external service that categorizes the message as containing misinformation, based on predefined criteria or databases of known false information. The results from this analysis are incorporated into the structured query generated by the Analysis Module 304, enabling the on-premise AI model 202 to assess the overall risk of the communication, including both social engineering tactics and misinformation. This functionality enhances the ability of social engineering detection system 104 to detect and mitigate risks associated with the spread of false information in messaging apps.

Furthermore, the analysis module 304 may classifies message entities to further enhance detection accuracy. This classification involves recognizing proper nouns (names of people, companies, or government institutions) and verifying their authenticity against a threat intelligence database. Linguistic models are used to analyze sentence structures, grammatical inconsistencies, and deceptive phrase patterns often employed in scams. In cases where the sender's previous messages exhibit a consistent communication style, any sudden irregularities—such as spelling errors in professional communication or the inclusion of unfamiliar terms, are considered potential signs of fraud.

By incorporating contextual memory and prior conversation analysis, the analysis module 304 improves its ability to detect ongoing social engineering tactics. It continuously evaluates conversation flow and historical interactions to identify subtle forms of deception. For example, if an imposter attempts a long-term scam by initially engaging in casual conversation before making a fraudulent request, the system detects the gradual deviation from standard conversation history. The analysis module 304 may also apply machine learning-based anomaly detection to flag cases where a conversation does not align with expected norms based on historical data.

In an embodiment, the AI interaction module 306 is responsible for generating structured queries based on the insights derived from the analysis module 304 and submitting them to the on-premise AI model 202 for evaluation. In an example, the queries generated by the AI interaction module 306 may be prompts to be fed to the on-premise AI model 202. The AI interaction module 306 generates structured queries based on insights from the analysis module 304 and submits them to the on-premise AI model 202 for evaluation. The on-premise AI model 202 supplies its own APIs and interacts with the social engineering detection system 104 through an AI model library. This library acts as an intermediary, enabling seamless communication between the social engineering detection system 104 and the on-premise AI model 202. The structured queries are formatted in a way compatible with the APIs of on-premise AI model 202, ensuring efficient and secure data exchange. This approach allows the social engineering detection system 104 to leverage the on-premise AI model 202 capabilities locally, without relying on external cloud services or system-level APIs, maintaining privacy and real-time processing. In an alternative embodiment, system APIs of the electronic device 102 or system software running on the electronic device 102 may be used for this purpose. The AI interaction module 306 acts as an intermediary between the risk assessment process and the decision-making capabilities of the on-premise AI model 202, ensuring that all relevant context is preserved when analysing potential social engineering attacks.

The AI interaction module 306 may utilize the on-premise AI model 202 to evaluate structured queries generated from the extracted content. The on-premise AI model 202 is a pre-trained deep learning model fine-tuned to detect social engineering tactics, such as phishing, impersonation, and urgency-based language. The on-premise AI model 202 analyses the structured queries, which include text data, metadata, and identified communication risk factors, and assigns a confidence score to indicate the likelihood of a social engineering attack. The output of the on-premise AI model 202 is sent to the response reception module 308 for further processing. This integration ensures accurate and context-aware threat detection while preserving data privacy through on-premise processing.

The AI interaction module 306 constructs structured queries that encapsulate key attributes of a conversation, including extracted text, sender metadata, message intent, urgency levels, linguistic patterns, and behavioural anomalies. The structured query is formatted in a way that allows the on-premise AI model 202 to process it efficiently, ensuring that the AI can accurately assess the likelihood of deceptive intent within the conversation. The AI interaction module 306 also normalizes the extracted content, removes redundant information, and structure it into a query-specific format, thus, ensures that the on-premise AI model 202 receives clean, relevant, and contextually rich data for evaluation.

Once the structured query is generated, the AI interaction module 306 submits it to the on-premise AI model 202, which then processes the query using deep learning techniques, statistical modelling, and contextual pattern recognition algorithms. The on-premises AI model 202 evaluates the structured query against pre-trained data models that contain historical social engineering attack patterns, common scam tactics, and phishing conversation structures. The on-premise AI model 202 may apply neural network-based probability estimation techniques to determine how closely the extracted conversation matches known fraudulent communication strategies.

As part of the assessment, the AI interaction module 306 may structure the query in a way to instruct the on-premise AI 202 model to assign a confidence score that quantifies the likelihood that the extracted content is part of a social engineering attack. The confidence score is derived using a combination of pattern matching, contextual inference, and machine learning-based anomaly detection, ensuring that the evaluation is robust and adaptable to evolving attack strategies. The confidence score serves as an important indicator of risk, helping the system differentiate between low-risk, moderate-risk, and high-risk threats.

Additionally, the confidence score may be dynamically adjusted based on external threat intelligence data obtained through retrieval-augmented generation (RAG) model 204. By incorporating real-time cybersecurity intelligence reports, previously detected phishing cases, and newly emerging social engineering tactics, the on-premise AI model 202 refines its assessment and enhances the accuracy of the confidence score. This ensures that even sophisticated or novel attack methods can be effectively identified. In an additional embodiment, the AI interaction module 306 may be capable of generating the confidence score as described above.

Once the confidence score is computed, the AI interaction module 306 transmits the evaluation results of on-premise AI model 202 back to the social engineering detection system 104 or the processor 212 associated with the social engineering detection system 104, allowing subsequent modules (such as the intervention module 310 and filter module 312) to take appropriate actions. If the confidence score surpasses a pre-defined risk threshold, the social engineering detection system 104 may generate intervention prompts or warnings to alert the user of potential deception within the conversation.

By systematically transforming unstructured conversation data into AI-processable structured queries and integrating confidence-based threat assessment, the AI interaction module 306 ensures a scalable, adaptable, and intelligent approach to detecting social engineering attacks in real time.

In an embodiment, the response reception module 308 is responsible for handling and processing the output generated by the on-premise AI model 202, ensuring that the social engineering detection system 104 can act on detected threats in real-time. The response reception module 308 acts as an intermediary between the evaluation by the on-premise AI model 202 and the decision-making processes of the social engineering detection system 104. The response reception module 308 processes and interprets the response of on-premise AI model 202, which may include a confidence score quantifying the likelihood of a social engineering attack and a threat classification label that categorizes the type of potential attack, such as phishing, impersonation, or financial fraud. Additionally, the response reception module 308 may incorporate supplementary AI inferences, providing contextual details about why a particular communication is flagged as suspicious.

Upon receiving evaluation from the on-premise AI model 202, the evaluation is received through APIs of the on-premise AI model 202, which facilitate communication between the on-premise AI model 202 and the social engineering detection system 104. The response reception module 308 determines the appropriate course of action based on the confidence score and classification. If the confidence score exceeds a predefined threshold, the response reception module 308 flags the communication as high-risk and forwards the risk classification to the intervention module 310, which then alerts the user with a warning or verification prompt. For moderate-risk cases, the module may apply a risk-level tag and allow further analysis before escalating an intervention. By establishing dynamic risk thresholds, the module ensures that urgent threats receive immediate prioritization, while borderline cases are further evaluated based on additional system intelligence or user feedback.

To facilitate seamless system-wide communication, the response reception module 308 standardizes the output of the on-premise AI module 202 into a structured format that other components can process efficiently. This may involve optimizing real-time data transfer mechanisms to prevent delays and implementing risk escalation mechanisms that allow messages with uncertain risk assessments to be reevaluated. Additionally, the response reception module 308 may support adaptive risk mitigation techniques through a feedback loop with the on-premise AI model 202. If a user overrides a flagged message, for example, marking a detected scam as legitimate, the module records this decision and transmits it back to the on-premise AI model 202 to refine future detection accuracy through continuous learning.

By efficiently processing and relaying the on-premise AI model 202 confidence scores, classifications, and risk assessments, the response reception module 308 ensures that social engineering threats are identified, flagged, and responded to in a timely and intelligent manner. Its integration with other modules, such as the intervention module 310 and AI interaction module 306, enables a real-time, adaptive approach to mitigating deceptive attacks while minimizing false positives and user disruption.

In an embodiment, the intervention module 310 is responsible for generating context-aware intervention prompts based on the output received from the response reception module 308, which in turn processes the confidence score and classification of potential social engineering attacks by on-premise AI model 202. The intervention module 310 facilitates real-time threat mitigation by providing users with actionable prompts, verification mechanisms, and security advisories to help them assess and respond to suspicious communications.

The intervention module 310 may generate intervention prompts based on the confidence score provided by the on-premise AI model 202. These prompts are dynamically adapted to the context of the detected threat, ensuring that the user receives relevant and actionable guidance in response to a flagged message. The module employs real-time risk assessment logic, wherein the content, sender details, and message context are automatically analysed to generate a context-sensitive prompt. If a conversation exhibits characteristics of a social engineering attack, the social engineering detection system 104 triggers a corresponding intervention prompt that alerts the user about potential risks while suggesting verification methods.

One of the primary intervention strategies of the intervention module 310 is to present messages that encourage skepticism towards the sender of the extracted content. If the on-premise AI model 202 detects anomalies in a conversation, such as inconsistencies in message structure, an unknown sender impersonating a trusted contact, or an abrupt shift in tone, the intervention module 310 may generates a cautionary warning. This warning explicitly advises the user to approach the conversation with caution, reinforcing cybersecurity best practices such as avoiding unsolicited requests for sensitive information and verifying unexpected financial transactions through alternative channels.

To enhance security, the intervention module 310 may present authentication challenges to verify the identity of the sender, which is particularly useful in preventing impersonation attacks where an attacker mimics a legitimate contact or organization. If a conversation is flagged as high-risk, the intervention module 310 prompts the user to authenticate the sender through alternative verification methods, such as confirming the sender’s identity via a known secure communication channel, cross-referencing with previous conversations to detect inconsistencies, or requesting additional authentication steps, such as confirming a passphrase or answering a known security question. These measures add an extra layer of verification, ensuring that the user does not unknowingly engage with fraudulent or deceptive entities.

The intervention module 310 provides meaningful interventions backed by cybersecurity principles and behaviour change theories. Since imposter scams rely on tricking users into believing the scammer is someone they trust, the module instils doubt in the user when a social engineering tactic is detected. This is particularly applied to messages from contacts not in the user’s contact list. Scammers may impersonate someone the user knows in real life or a person in a position of authority, such as a government representative. In such cases, the intervention module 310 generates context-aware prompts to help the user verify the sender’s identity.

In cases where a potential social engineering attack is detected, the module suggests context-aware verification questions based on the specifics of the flagged communication. These questions are dynamically generated using linguistic analysis and contextual risk evaluation, allowing the user to challenge the sender with queries that an impersonator would struggle to answer. For example, if a message claims to be from a bank requesting urgent account updates, the intervention module 310 may suggest asking, "Can you confirm the last transaction I made?" or "What is the secure keyword I set up with customer support?" This approach adds an extra layer of validation before the user interacts further with a potentially fraudulent entity.

To further reinforce user awareness, the intervention module 310 can display official cybersecurity advisories and government notices relevant to the specific type of detected threat. By integrating real-time threat intelligence sources, such as national cybersecurity agencies, corporate security bulletins, and law enforcement advisories, the intervention module 310 may ensures that users receive authoritative guidance on handling emerging social engineering tactics. If the flagged message resembles a known phishing attempt or scam, the social engineering detection system 104 automatically retrieves and displays an official advisory, warning the user about the latest fraudulent schemes and preventive measures.

Another function of the intervention module 310 is to generate and display risk scores indicating the likelihood of a detected message being a social engineering attack. The intervention module 310 may translates the confidence score provided by the on-premise AI model 202 into a user-friendly risk indicator, categorizing messages as Low Risk, where the message exhibits minor irregularities but is not conclusively malicious; Moderate Risk, where certain linguistic patterns or sender behaviours are inconsistent with prior interactions; or High Risk, where the on-premise AI model 202 has identified multiple strong indicators of deception, requiring immediate caution. This quantified risk assessment helps users make informed decisions before engaging with potentially deceptive communications, reducing the likelihood of falling victim to social engineering attacks.

To assist users in recognizing social engineering tactics, the intervention module 310 highlights suspicious linguistic patterns found in the extracted content, which may include urgency-based language, such as "Immediate action required!" or "Your account will be locked soon!"; financial manipulation cues, like "Wire transfer this amount now" or "Your loan application is pending approval, click here."; and emotional persuasion tactics, including "I am in trouble, please help me" or "This is a once-in-a-lifetime opportunity!". By visually emphasizing these high-risk phrases, the system enhances user awareness of deceptive language structures, helping them recognize and resist fraudulent messages more effectively.

To further assist users in detecting fraud, the intervention module 310 tailors’ verification questions based on the specific context of a suspicious message, ensuring that queries remain relevant to the type of impersonation attempt. For instance, if a message appears from a friend or family member, the intervention module 310 may prompt the user to ask, "When did we last meet in person?" or "What’s the name of my pet?"; if a message claims to be from a financial institution, the system may suggest asking, "Can you confirm my last official communication with you?" or "Provide the last four digits of my registered account number."; and if an email purports to be from an employer or colleague, the system may prompt the user to ask, "What was the subject of our last email conversation?". These context-sensitive verification questions significantly reduce the risk of falling victim to impersonation attacks, as fraudsters typically lack access to personal historical information, making it more difficult for them to convincingly respond.

In an embodiment, the filter module 312 is responsible for processing the output of the on-premise AI model 202 and determining whether a communication should be flagged as suspicious based on the confidence score and risk classification provided by the AI. Unlike traditional security systems that automatically block or quarantine potentially harmful messages, the filter module 312 may employ a user-centric filtering approach that allows users to remain in control of their communications while receiving clear, actionable warnings about potential threats. By analysing the context, sender metadata, and linguistic patterns within a message, the filter module 312 determines whether the communication exhibits characteristics of social engineering attempts and applies appropriate risk-based filtering mechanisms.

The filter module 312 evaluates the risk assessment of the on-premise AI model 202 and applies a context-driven filtering mechanism to process the extracted content. If the confidence score generated by the on-premise AI model 202 indicates a potential social engineering attack, the filer module 312 flags the communication as suspicious. Rather than automatically removing or restricting access to the message, the filter module 312 alerts the user by displaying a warning message or risk indicator, allowing them to assess the threat before engaging further. The filter module 312 also provides explanatory insights into why a particular communication was flagged, such as detected urgency-based language, financial manipulation cues, or inconsistencies in sender behaviour. This approach ensures that the user remains informed while avoiding unnecessary disruptions to legitimate conversations.

Additionally, the filter module 312 may incorporate adaptive filtering techniques that allow it to apply different levels of intervention based on the severity of the detected risk. The filter module 312 may block, delay, or restrict interactions depending on the likelihood of a message being fraudulent. If a message is classified as low-risk, the module may simply provide a cautionary label, advising the user to proceed carefully. For moderate-risk messages, the social engineering detection system 104 may introduce a delayed interaction, requiring the user to acknowledge the warning before responding. In cases where the on-premise AI model 202 assigns a high-risk classification, the filter module 312 can impose temporary interaction restrictions, such as requiring additional verification steps before the user can reply to or act on the message. This multi-tiered filtering approach reduces the likelihood of false positives, ensuring that legitimate communications are not inadvertently blocked while providing strong protection against deceptive social engineering attacks.

In an embodiment, the knowledge augmentation module 314 is designed to enhance the detection accuracy and contextual of social engineering detection system 104 by leveraging the RAG model 204. The knowledge augmentation module 314 retrieves and adds real-time threat intelligence data to the evaluation process of on-premise AI model 202. The knowledge augmentation module 314 fetches external cybersecurity reports, phishing attempt logs, and other relevant information. This allows the on-premise AI model 202 to analyse threats using a broader, knowledge-enriched context, rather than relying only on pre-trained data. As a result, the social engineering detection system 104 becomes better at detecting new, complex, and unknown social engineering tactics.

The knowledge augmentation module 314 integrates RAG-based threat intelligence retrieval into decision-making workflow social engineering detection system 104. When the on-premise AI model 202 processes a structured query related to a potential social engineering attack, the module automatically queries threat intelligence databases, cybersecurity feeds, and internal fraud detection logs to retrieve relevant case studies, historical fraud patterns, and risk assessments associated with similar incidents. For example, if the extracted content includes a suspicious hyperlink or an unknown sender’s email address, the module performs a real-time lookup to determine if the URL has been previously flagged as malicious or if the sender has been reported in prior phishing attempts. This retrieval process enables the on-premise AI model 202 to contextualize risk assessments with up-to-date threat data, improving accuracy and adaptability.

The knowledge augmentation module 314 enhances the decision-making accuracy of the on-premise AI model 202 by integrating with the RAG model 204. The RAG mechanism retrieves relevant threat intelligence data, such as phishing attempt logs and cybersecurity reports, from external databases. This data is incorporated into the evaluation process of the on-premise AI model 202, enabling it to refine its assessment and generate more accurate outputs. For example, if the extracted content contains a suspicious link, the RAG mechanism retrieves historical data about similar links and provides it to the on-premise AI model 202. The on-premise AI model 202 then uses this additional context to improve its detection accuracy. This integration ensures that the social engineering detection system 104 can adapt to evolving social engineering tactics and provide robust protection against emerging threats.

The RAG framework implemented in this module enhances the inference capabilities of the on-premise AI model 202 by supplementing its existing deep learning-based text analysis with external factual knowledge. When a potential scam message is detected, the module cross-references details from external intelligence feeds (such as government cybersecurity agencies, corporate fraud prevention databases, and financial institution security alerts) to determine whether the message aligns with known attack patterns. This approach allows the social engineering detection system 104 to identify and flag new fraud schemes that were not explicitly included in the original training dataset, on-premise AI model 202.

Moreover, the knowledge augmentation module 314 dynamically updates the knowledge base of on-premise AI model 202, ensuring that newly discovered threat vectors are incorporated into the system’s detection capabilities. By continuously refining the on-premises AI model 202 decision-making with real-time intelligence, the module enables the social engineering detection system 104 to adapt to evolving cyber threats, phishing tactics, and social engineering schemes more effectively. This proactive threat intelligence integration ensures that the system is not limited by static training data but instead remains highly adaptive to new fraud techniques.

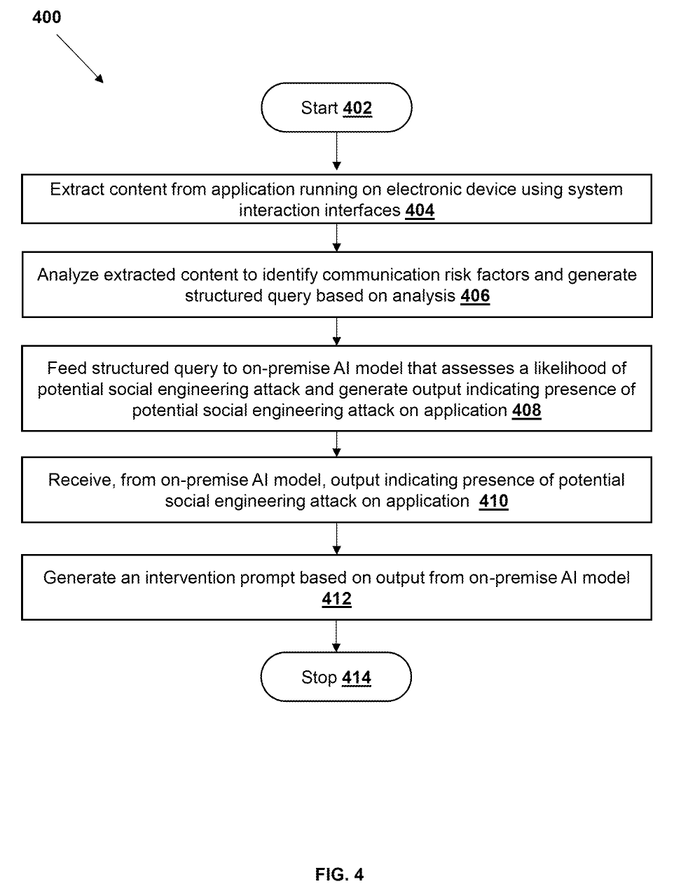

FIG. 4 is a flow chart that illustrates operations of an exemplary method for detection of social engineering attacks, in accordance with an embodiment of the present disclosure.FIG. 4 is described in conjunction with elements from FIG. 1, FIG. 2, and FIG. 3. With reference to FIG. 4, there is shown a flowchart 400. The flowchart 400 may include operations from 402 to 416 and may be implemented by the electronic device 102 or social engineering detection system 104 in conjunction with the processor 212 of FIG. 1 and FIG. 2. The flowchart 400 may start at 402 and proceed to 404.

At 404, content may be extracted from an application running on an electronic device 102 using system interaction interfaces. The content extraction module 302 may be configured to extract the content from the application. Details related to the extraction of the content are further provided, for example, in FIG. 3 (at 302).

At 406, the extracted content may be analysed to identify communication risk factors, and a structured query may be generated based on the analysis. The analysis module 304 may be configured to analyse the extracted content and generate the structured query. Details related to the analysis of the extracted content are further provided, for example, in FIG. 3 (at 304).

At 408, the structured query may be fed to the on-premise AI model, which may assess the likelihood of a potential social engineering attack and generate an output indicating the presence of the potential social engineering attack on the application. The AI interaction module 306 may be configured to feed the structured query to the on-premise AI model 202. Details related to the interaction with the on-premise AI model 202 are further provided, for example, in FIG. 3 (at 306).

At 410, the output indicating the presence of a potential social engineering attack on the application may be received from the on-premise AI model 202. The response reception module 308 may be configured to receive the output from the on-premise AI model 202. Details related to the reception of the output are further provided, for example, in FIG. 3 (at 308).

At 412, an intervention prompt may be generated based on the output from the on-premise AI model 202. The intervention module 310 may be configured to generate the intervention prompt. Details related to the generation of the intervention prompt are further provided, for example, in FIG. 3 (at 310). Control may pass to Stop 414.

Although the flowchart 400 is illustrated as discrete operations, such as 404,406,408,410,412, and 414, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 or the social engineering detection system 104 of FIG. 1). Such instructions may cause the electronic device 102 or the social engineering detection system 104 to perform operations that may include extraction of content from an application running on an electronic device (e.g., the electronic device 102) using system interaction interfaces, such as the accessibility service API or optical character recognition (OCR). The operations may further include analysis of the extracted content by the analysis module 304 to identify communication risk factors and generation of a structured query based on the analysis.

Additionally, the operations may include feeding the structured query to the on-premise AI model 202, which assesses the likelihood of a potential social engineering attack and generates an output indicating the presence of the potential social engineering attack on the application. The operations may also include receiving, from the on-premise AI model 202, the output through the response reception module 308, which processes the output for further action. Finally, the operations may include generating an intervention prompt by the intervention module 310 based on the output from the on-premise AI model 202, wherein the intervention prompt is configured to facilitate verification of the sender’s authenticity within the application. These instructions enable the electronic device 102 or the social engineering detection system 104 to provide real-time, privacy-preserving detection and mitigation of social engineering attacks.

Exemplary aspects of the disclosure may provide an electronic device (such as, the electronic device 102 of FIG. 1) that includes a processor (such as, the processor 212). The processor 212 may be configured to extract content from an application running on the electronic device 102 using system interaction interfaces, such as the Accessibility Service API or Optical Character Recognition (OCR). The processor 212 may be configured to analyse the extracted content using the analysis module 304 to identify communication risk factors and generate a structured query based on the analysis. The processor 212 may be configured to feed the structured query to the on-premise AI model 202, which assesses the likelihood of a potential social engineering attack and generates an output indicating the presence of the potential social engineering attack on the application. The processor 212 may be configured to receive, from the on-premise AI model 202, the output through the response reception module 308, which processes the output for further action. The processor 212 may be configured to generate an intervention prompt using the intervention module 310 based on the output from the on-premise AI model 202, wherein the intervention prompt is configured to facilitate verification of the sender’s authenticity within the application. These operations enable the electronic device 102 or the social engineering detection system 104 to provide real-time, privacy-preserving detection and mitigation of social engineering attacks..

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steppers may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for detecting social engineering attacks, comprising:
extracting content from an application running on an electronic device using system interaction interfaces;
analysing the extracted content to identify communication risk factors;
generating a structured query based on the analysis;
feeding the structured query to an on-premise AI model that assesses a likelihood of a potential social engineering attack and generates an output indicating a presence of the potential social engineering attack on the application;
receiving, from the on-premise AI model, the output indicating the presence of the potential social engineering attack on the application; and
generating an intervention prompt based on the output from the on-premise AI model, wherein the intervention prompt is configured to facilitate verification of the sender’s authenticity within the application.

2. The method of claim 1, wherein the communication risk factors comprise at least one of linguistic patterns, contextual attributes, sender-related information, behavioural anomalies, psychological manipulation indicators, or message structure characteristics.

3. The method of claim 2, wherein
the sender-related information comprises determining whether a sender of the extracted content is in a predefined contact list associated with the application,
the behavioural anomalies comprise detecting unusual message patterns indicative of social engineering, including urgency, financial requests, or impersonation attempts,
the linguistic patterns comprise classifying entities within the extracted content to identify persons, organizations, or government agencies, and
the contextual attributes comprise assessing prior interactions with the sender to detect anomalies in conversation patterns.

4. The method of claim 1, wherein extracting the content comprises capturing text data or image-based text from the application.

5. The method of claim 3, wherein capturing image-based text includes using Optical Character Recognition (OCR) to extract textual information from screenshots or chat interfaces.

6. The method of claim 1, wherein the on-premise AI model assigns a confidence score to the likelihood of the social engineering attack.

7. The method of claim 6, wherein generating the intervention prompt includes suggesting one or more verification questions based on the confidence score from the on-premise AI model.

8. The method of claim 1, wherein generating the intervention prompt includes presenting a message that encourages scepticism towards a sender of the extracted content.

9. The method of claim 1, wherein generating the intervention prompt includes displaying an authentication challenge to verify a sender of the extracted content.

10. The method of claim 1, wherein generating the intervention prompt includes suggesting one or more verification questions based on prior interactions associated with a sender of the extracted content.

11. The method of claim 1, wherein generating the intervention prompt includes displaying official cybersecurity advisories or government notices relevant to the potential social engineering attack.

12. The method of claim 1, wherein generating the intervention prompt includes displaying a risk score indicating the likelihood of the extracted content being associated with the potential social engineering attack.

13. The method of claim 1, wherein generating the intervention prompt includes highlighting suspicious linguistic patterns, such as urgency-based language or financial requests, within the extracted content.

14. The method of claim 10, wherein the verification questions are selected based on context of a message in the extracted content, including whether the sender is impersonating a known contact or a financial institution.

15. The method of claim 1, further comprising filtering the extracted content upon determining, based on the output from the on-premise AI model, that the extracted content is associated with the potential social engineering attack.

16. The method of claim 14, wherein filtering comprises blocking, delaying, or restricting interactions based on the likelihood of the potential social engineering attack.

17. The method of claim 1, wherein feeding the structured query to the on-premise AI model includes utilizing Retrieval-Augmented Generation (RAG) to enhance detection accuracy by retrieving relevant threat intelligence data and incorporating it into the on-premise AI model’s response.

18. The method of claim 1, further comprises integrating the application with the on-premise AI model using APIs supplied by the on-premise AI model for communication and processing, wherein the integration is performed using an AI model library.

19. A non-transitory computer-readable medium having stored thereon computer-executable instructions, which when executed by one or more processors, cause the one or more processors to execute operations comprising:
extracting content from an application running on a electronic device using system interaction interfaces;
analysing the extracted content to identify communication risk factors;
generating a structured query based on the analysis;
feeding the structured query to an on-premise AI model that assesses a likelihood of a potential social engineering attack and generates an output indicating a presence of the potential social engineering attack on the application;
receiving, from the on-premise AI model, the output indicating the presence of the potential social engineering attack on the application; and
generating an intervention prompt based on the output from the on-premise AI model, wherein the intervention prompt is configured to facilitate verification of the sender’s authenticity within the application.

20. A system for detecting social engineering attacks, comprising:
a processor; and
a non-transitory memory storing instructions that, when executed by the processor, cause the system to:
extract content from an application running on a electronic device using system interaction interfaces;
analyse the extracted content to identify communication risk factors;
generate a structured query based on the analysis;
feed the structured query to an on-premise AI model that assesses a likelihood of a potential social engineering attack and generates an output indicating a presence of the potential social engineering attack on the application;
receive, from the on-premise AI model, the output indicating the presence of the potential social engineering attack on the application; and
generate an intervention prompt based on the output from the on-premise AI model, wherein the intervention prompt is configured to facilitate verification of the sender’s authenticity within the application.
